(19) United States
(12) Patent Application Publication
(10) Pub. No.: US 2009/0326824 A1
(43) Pub. Date: Dec. 31, 2009

(54) Method and device for the autonomous determination of wind speed vector

(76) Inventors: Michael Naumov, Givatayim (IL); George Naumov, Tel Aviv (IL)

Correspondence Address: MICHAEL NAUMOV, 3 HAZOR STREET, TEL AVIV, 69016, IL

(21) Appl. No.: 12/218,186

(22) Filed: Jul. 14, 2008

(30) Foreign Application Priority Data
Jun. 30, 2008 (IL) 192518

(51) Int. Cl. G01W 1/00; G06F 19/00

(52) U.S. Cl. 702/3; 702/50

(57) ABSTRACT

The present technical solution provided for the autonomous determination of wind speed vector is intended for the accurate determination of wind speed vector as well sea current, only by the means located in a moving object without applying any radiations and gyroscopes, and also without applying any sources of information and reference marks on the Earth and other heavenly bodies.

Such determination is proposed for the first time and is if paramount importance for the navigation purposes, in particular, for the determination of ground speed vector of a moving object and also for meteorology. This solution is based on the determination and transformation of the horizontal projections of linear acceleration vector of the moving object by means of the sensors of acceleration developed by the authors previously with applying the value of the course of a moving object and its speeds.

### FIELD OF ART

The technical solution provided relates, mainly, to the application in navigation and meteorology at any flight altitude, and while determining vector velocity of sea (water) current at any diving depth in water.

### BACKGROUND OF THE INVENTION

Wind speed vector (or sea current speed vector) [symbol] is said to be characterized by its value (module) U and direction δ (the angle between the northern direction N of true meridian and vector

[symbol]

Under autonomous determination in the present application it is understood (meant) the one to be implemented only by the means to be located inside a moving object (in particular, vehicle one) without applying any radiations (Doppler's, for example), magnet field of the Earth, ground and heavenly sources of information and reference marks.

Such autonomous determination of wind speed vector (or sea current speed vector) in the prior art has not been discovered by the authors.

The present technical solution has for its purpose to provide autonomous, accurate and quick determination of the wind speed vector (as well as sea current speed vector) irrespective of the flight altitude (diving depth in water).

### SUMMARY OF THE INVENTION

To meet the object of the present technical solution there is provided a method of autonomous determination of the wind speed vector (sea current speed vector), including the following stages:
determination of the longitudinal projection α_{ξ} of linear acceleration vector of a moving object (i.e. the vector at a tangent to the trajectory of movement) onto the longitudinal line (axis) of crossing ξ of the horizontal plane with the plane going through the vertical and longitudinal axes of said object, in particular, through the lines parallel to said axes,
determination of the transverse (lateral) projection α_{ζ} of said linear acceleration vector of said moving object onto the transverse line (axis) of crossing ζ of the horizontal plane with the plane going through the vertical and transverse (lateral) axes of said object, in particular, through the lines parallel to said axes,
determination of the longitudinal projection W₁ of ground speed vector W of said moving object onto said line of crossing ξ

W₁=∫α_{ξ}dt, (1)
determination of the transverse (lateral) projection W₂ of ground speed vector W of said moving object onto said line of crossing ζ

W₂=∫α_{ζ}dt, (2)
determination of true airspeed V, i.e. the speed relative to air (or the speed relative to water),
determination of the difference between said longitudinal projection W₁ of the ground speed vector of said moving object and its true air speed (or the speed relative to water), i.e. W₁−V,
determination of true course α of said moving object,
determination of the angle μ between said longitudinal projection W₁ of the ground speed vector and wind speed vector U (sea current)

$$= arc tg \frac{{W}_{2}}{{W}_{1} - V} , \qquad ( 3 )$$

determination of the direction δ of wind speed vector [symbol] (sea current)

δ=α+μ, (4)
determination of the value (module) U of wind speed vector [symbol] (sea current)

$$U = \sqrt{{( {W}_{1} - V )}^{2} - {W}_{2}^{2}} = \frac{{W}_{2}}{sin } = \frac{{W}_{1} - V}{cos } \qquad ( 5 )$$

Thus, the method as disclosed in this solution is the determination of U and δ by means of applying true airspeed V of true course α, the determination of the projections W₁ and W₂ of ground speed vector W of a moving object and the determination of elements U and μ of the triangle, the legs thereof being the values “W₁−V” and “W₂”.

In conformity with the method provided the device for its. implementation is considered to be fastened on a moving object and to consist of the two mutually interconnected:
two sensors (longitudinal and transverse), the determination of said projections a_{ξ} and a_{ζ} of the linear acceleration vector of a moving object,
sensor of true airspeed V of a moving object,
sensor of the true course α of a moving object,
computing unit, said sensors being switched thereto. From the output of said unit there are signals U, δ taken off as well as ground speed W of a moving object

W=\sqrt{W₁²+W₂²}. (6)
and true ground angle β of a moving object

$$\begin{matrix}β = α + Ψ , \\ where \\ Ψ \text{-} angle of drift & ( 7 ) \\ Ψ = arc tg \frac{{W}_{2}}{{W}_{1}} = \frac{\int {a}_{ζ} d t}{\int {a}_{ξ} d t} . & ( 8 )\end{matrix}$$

Each of the sensors of said projections a_{ξ} and a_{ζ} [1] is based on the determination of the difference of, summary acceleration (it including therein linear acceleration and difference of centrifugal accelerations) and the difference of centrifugal accelerations. In each of said sensors there are harmful influences eliminated (even in the tilting position) of the cross-sectional (vertical and horizontal) and centrifugal (centripetal) accelerations.

Coriolis accelerations can be ignored with higher accuracy due to the following considerations:
longitudinal projection W₁ of ground speed vector W is considered to cause Coriolis acceleration, it being directed perpendicular to said projection, i.e. being cross-sectional acceleration, any harmful influence thereof in said sensors [1] are considered to be eliminated;
transverse projection W₂ of ground speed vector W caused, mainly, by wind (sea current) being commensurable with the ground vehicle speed is considered to cause insignificant Coriolis acceleration, it not being more than millesimal of 1 m/sec₂.

Therefore, with considerably higher accuracy it is possible to say that the values α_{ξ} and α_{ζ} to be determined are the projections of the linear acceleration vector onto said axes (lines) of crossing ξ and ζ.

Moreover, in case of special necessity a considerably insignificant error to be caused by Coriolis acceleration can be taken into account by means of the known mathematical formula. Since this very error is considered to be insignificant (minor), then for its determination it is enough to know an approximate value of the projection W₂.

Thus, the determination of wind speed vector (sea current) is accompanied the definition of the ground speed vector, it enabling one, in its turn, to determine autonomous coordinates of the location of a moving object.

As the base of the sensor of true airspeed V use can be made of the velocimeter of said speed which can be applied on each aircraft This velocimeter is based on measuring dynamic pressure of air.

The true course a can be determined by means of known prior art (magnetic, astronomic, gyroscopic) as well as by means of the method developed by the authors previously [2], wherein there are considerable drawbacks and shortcomings of the prior art eliminated.

### BRIEF DESCRIPTION OF THE INVENTION

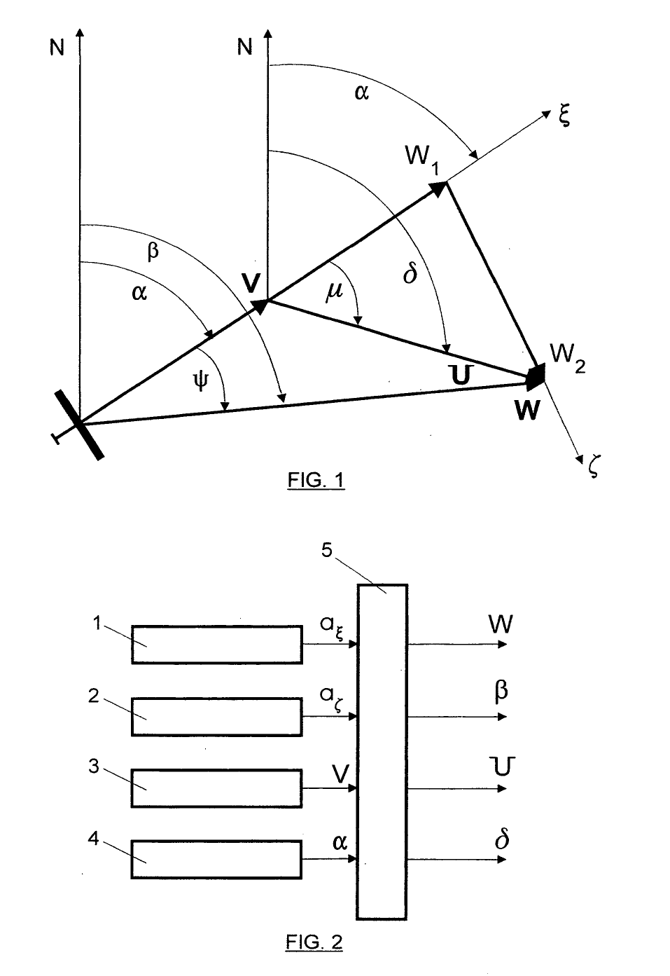

The technical solution provided is illustrated in the accompanying drawings FIG. 1 and FIG. 2.

FIG. 1 is a navigational triangle consisting of 3 vectors: true air speed vector V, wind speed vector U and ground speed vector W of a moving object with its projections W₁ and W₂ onto said horizontal axes ξ and ζ.

FIG. 2 is a structural scheme of the device provided.

### DETAILED DESCRIPTION OF THE INVENTION

According to the technical solution the method of the determination of wind speed vector (see current) [symbol] (its value U and direction δ) consists in applying true airspeed V, true course α, the determination of projections W₁ and W₂ of ground speed vector, as well as the determination of the triangle elements (hypotenuse, it being module [symbol] of wind speed vector and angle μ included thereto), the legs are the values W₁−V and W₂ thereof.

The device implementing the method provided (FIG. 2) is fastened on a moving object, and consists of mutually interconnected:
sensor 1 [1] determining said longitudinal projection α_{ξ} of linear acceleration vector of said moving object onto the longitudinal line (axis) ξ of crossing of the horizontal plane with the plane going through the vertical and longitudinal axes of a moving object, in particular, through the lines parallel to said axes,
sensor 2 [1] determining transverse projection α_{ζ} of linear acceleration vector of a moving object onto the transverse line (axis) ζ of crossing the horizontal plane with the plane going through the vertical and transverse axes of a moving object, in particular, through the lines parallel to said axes,
sensor 3 of the true airspeed V of a moving object,
sensor 4 [2] of the true course a of a moving object,
computing unit 5, from the output thereof there is the value U of air speed vector taken 0ff (of sea current) and its direction δ as well as the value W of the ground speed vector of a moving object and its true ground angle β. Said sensors are switched to computing unit 5.

Each of the sensors 1 and 2 is based on the determination of the difference of the summary acceleration (it including linear acceleration and the difference of centrifugal accelerations) and difference of centrifugal accelerations.

Vessels of sensor 1 are fastened on a moving object so that the cross-sections of the inner cavities of said vessels containing the points of determining pressure went through the vertical and longitudinal axes of said object, in particular, through the lines parallel to said axes.

Vessels of sensor 2 are fastened on a moving object so that the cross-sections of the inner cavities of said vessels containing the points of determining pressure went through the vertical and transverse axes of said object, in particular, through the lines parallel to said axes.

Sensor 3 of the true airspeed V is based on the determination of the dynamic pressure.

Sensor 4 of the course is based on the determination of true course δ by means of any known method (magnetic, astronomic, gyroscopic) as well as on the method developed and created by the authors [2], wherein there are considerable drawbacks and shortcomings of the prior art eliminated.

In computing unit 5 technical implementation is made of the equations:

$$\begin{matrix}{W}_{1} = \int {a}_{ξ} d t , & ( 1 ) \\ {W}_{2} = \int {a}_{ζ} d t , & ( 2 ) \\ = arc tg \frac{{W}_{2}}{{W}_{1} - V} , & ( 3 ) \\ U = {\sqrt{{( {W}_{1} - V )}^{2} + {W}_{2}^{2}}}^{δ = + ,} & ( 4 ) \\ \begin{matrix} = \frac{{W}_{2}}{sin } \\ = \frac{{W}_{1} - V}{cos } , \end{matrix} & ( 5 ) \\ W = \sqrt{{W}_{1}^{2} + {W}_{2}^{2}} , & ( 6 ) \\ β = α + Ψ , & ( 7 ) \\ Ψ = arc tg \frac{{W}_{2}}{{W}_{1}} & ( 8 )\end{matrix}$$

### Considerable Distinguishing Features of the Solution Provided

for the first time the solution is provided of the autonomous determination of wind speed vector (sea current),

determination of the angle between the longitudinal projection of the ground speed vector and wind speed vector (sea current),

determination of the difference between the longitudinal projection of the ground speed vector and the value of true airspeed (the speed relative to water),

determination of the projections the linear acceleration vector,

determination of the projections of ground speed vector.

### Advantages and Merits of the Solution Provided

autonomous determination of the wind speed vector (sea current);
possibility of the autonomous determination of the ground speed vector;
possibility of said autonomous determinations without applying gyroscopes;
accurate, quick determination of said vectors.

We claim:

1. A method for the autonomous determination of wind speed vector, which including the following stages being mutually interconnected:
determination of the longitudinal projection of linear acceleration vector of a moving object onto the longitudinal line of crossing the horizontal plane with the plane going through the vertical and longitudinal axes of said object, in particular, through the lines parallel to said axes,
determination of the transverse projection of linear acceleration vector of a moving object onto the transverse line of crossing the horizontal plane with the plane going through the vertical and transverse axes of said object, in particular, through the lines parallel to said axes,
determination of true air speed of a moving object,
determination of true course of a moving object,
determination of the longitudinal projection of ground speed vector of a moving object onto said longitudinal line of crossing,
determination of the longitudinal projection of ground speed vector of a moving object onto said transverse line of crossing,
determination of wind speed vector,
determination of the value of wind speed vector.

2. A method as set forth in claim 1, wherein technical implementation of the equations being made
$${W}_{1} = \int {a}_{ξ} d t , {W}_{2} = \int {a}_{ζ} d t , W = \sqrt{{W}_{1}^{2} + {W}_{2}^{2}} , \\ \\ δ = α + μ , \\ U = \sqrt{{( {W}_{1} - V )}^{2} + {W}^{2}} . \qquad$$
where
a_{ξ}, a_{ζ}—longitudinal and transverse projections of linear acceleration vector of a moving object onto said longitudinal and transverse lines of crossing,
α—true course of a moving object,
W₁, W₂—longitudinal and transverse projections of the ground speed of a moving object onto said longitudinal and transverse line of crossing,
W—ground speed of a moving object,
V—true airspeed of a moving object,
δ—direction of wind speed vector,
U—value of wind speed vector.

3. A device for the autonomous determination of wind speed vector, which being fastened on a moving object, and consisting of mutually interconnected:
a sensor of longitudinal projection of linear acceleration vector of a moving object onto the line of crossing of the horizontal plane with the plane going through the vertical and longitudinal axes of said object, in particular, through the lines parallel to said axes,
a sensor of transverse projection of linear acceleration vector of a moving object onto the line of crossing the horizontal plane with the plane going through the vertical and transverse lines of said object, in particular, through the lines parallel to said axes,
sensor of true airspeed of a moving object,
sensor of true course of a moving object,
computing init, from the output thereof there values of wind speed vector being taken off and its direction, and said sensors being switched thereto.
